(19) United States
(12) Patent Application Publication
(10) Pub. No.: US 2008/0091531 A1
(43) Pub. Date: Apr. 17, 2008

(54) CONSUMER INCENTIVE ARTICLE AND SYSTEM

(76) Inventor: George DAVIDHEISER, Linfield, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/847,875

(22) Filed: Aug. 30, 2007

Related U.S. Application Data
(60) Provisional application No. 60/841,162, filed on Aug. 30, 2006.

(51) Int. Cl. G06Q 30/00

(52) U.S. Cl. 705/14

(57) ABSTRACT

An incentive article for use by a business in providing an incentive to a first customer and a second customer is provided, including a card having a first portion including indicia thereon advising the first customer to provide the card to a second customer in order to receive an incentive, and a second portion including indicia thereon providing an incentive to a second customer for patronizing the business. A method for a business to provide an incentive to a first customer and a second customer is also provided, including the steps of: selecting incentives to be provided to a first customer and a second customer; providing a card including indicia for communicating the incentives to a first customer; associating the card with the first customer; transferring the card from the first customer to the second customer; and, providing one of the incentives to the second customer when the second customer returns the card to a business.

### CLAIM OF PRIORITY

This application claims priority from U.S. Provisional Application No. 60/841,162, filed Aug. 30, 2006, which is incorporated herein in its entirety by reference.

### FIELD OF INVENTION

The present invention relates to an article for promoting a business to a previously existing customer and to a potential new customer, and more particularly, to a system incorporating an incentive card for both a first (or original) customer, and a potential new customer other than the first (or original) customer.

### BACKGROUND

In the field of consumer incentive items and systems, businesses sometimes provide loyalty cards, which may look like credit cards, or other articles (such as plastic tabs for attaching to a keychain or key ring) for keeping track of the number of visits by an existing or original customer, in order to provide an incentive having that customer return to the business. Such incentive cards often provide a discount or free goods or services after a customer has visited a business a pre-determined number of times, or received a certain number of goods or services at pre-determined quantity.

However, such known incentive items and systems provide no incentive for “spreading the word” about a business, and do not provide a means for growing a business. While existing customers may return to the business, the existing customer has no incentive for advising potential new customers of the business.

Accordingly, there is a need for an incentive system and article that provides an incentive for a current, existing, or original customer to advise another potential or second customer about the business.

There is further the need for an incentive system and article where a second customer receives an incentive for patronizing a business upon receipt of an incentive article from a first customer.

### SUMMARY OF THE INVENTION

The present invention provides for an incentive article for use by a business in providing an incentive to a first customer and a second customer, including a card having a first portion including indicia thereon advising the first customer to provide the card to a second customer in order to receive an incentive, and a second portion including indicia thereon providing an incentive to a second customer for patronizing the business.

The present invention further provides for a method for a business to provide an incentive to a first customer and a second customer, including the steps of: selecting incentives to be provided to a first customer and a second customer; providing a card including indicia for communicating the incentives to a first customer; associating the card with the first customer; transferring the card from the first customer to the second customer; and, providing one of the incentives to the second customer when the second customer returns the card to a business.

### BRIEF DESCRIPTION OF THE DRAWINGS

FIG. 1 is a front view of an exemplary incentive card used in connection with the present invention.

FIG. 2 is a front view of an embodiment incentive card used in connection with the present invention.

FIG. 3 is a rear view of the incentive card of FIG. 2.

FIG. 4 is a schematic outlining the incentive system of the present invention.

FIG. 5 is a schematic outlining the incentive system of the present invention.

FIG. 6 is an illustrative representation of a first customer and a second customer utilizing incentive articles according to a system of the present invention.

FIG. 7 is an illustrative representation of a record keeping and/or tracking system that maybe utilized in the incentive system of the present invention.

### DETAILED DESCRIPTION OF THE PREFERRED EMBODIMENT(S)

A used herein, the term “first customer” is used to generally refer to a first, current or original customer that patronizes a business prior to referring a second customer.

As used herein, the term “second customer” is used to generally refer to a second, potential or new customer who receives an incentive article from a first customer so that a second customer will be enticed to patronize a business and receive an incentive.

As used herein, “incentive” means any incentive, enticement or inducement for encouraging or rewarding a customer for performing an act or series of acts, or for exhibiting a certain behavior advantageous to a business. An incentive may be a coupon, discount, reward, offer of free goods and/or services, any combinations thereof, or the like.

As used herein, “indicia” means any indicia, colors, text, illustration, design, graphics, any combinations thereof, or the like.

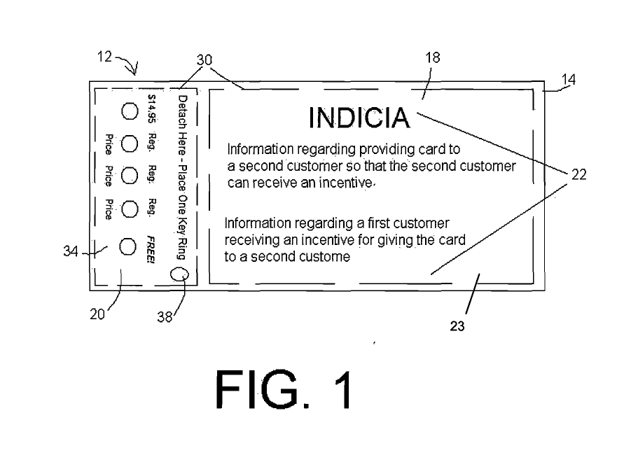

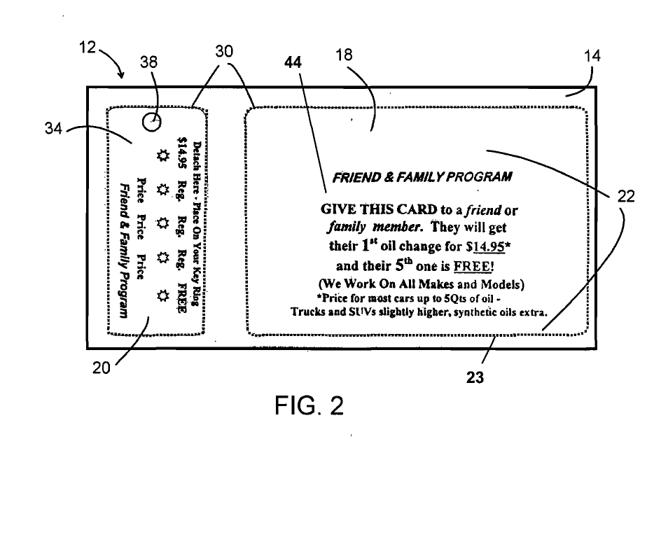

An incentive system 10 according to the prevent invention includes an incentive card 12, as shown in FIGS. 1-3. The card 12 includes a front face 14 and a rear face 16. The card 12, illustrated in FIGS. 1 and 2, preferably includes a first portion 18 and a second portion 20. The card 12 is preferably formed from plastic, paper or cardboard, and includes score lines 30 along the periphery of both the first portion 18 and the second portion 20, or dividing the first portion 18 and the second portion 20, so that either or both of the first portion 18 or second portion 20 may be separated and kept separately. The first portion 18 includes a front face 23 and a rear face 24. The second portion 20 includes a front face 34 and a rear face 36.

The first portion 18 preferably includes indicia 22 such as the name or advertising for a company using the incentive system 10 of the present invention. The first portion 18 is preferably sized approximately the size of a business card. It is appreciated that the first portion 18 and/or the second portion 20 may be sized according to the preferences of a business, for ease of use and convenience. Score lines 30 may be provided around the periphery of the first portion 18, so that the first portion 18 can be separated from the other portions of the card 12.

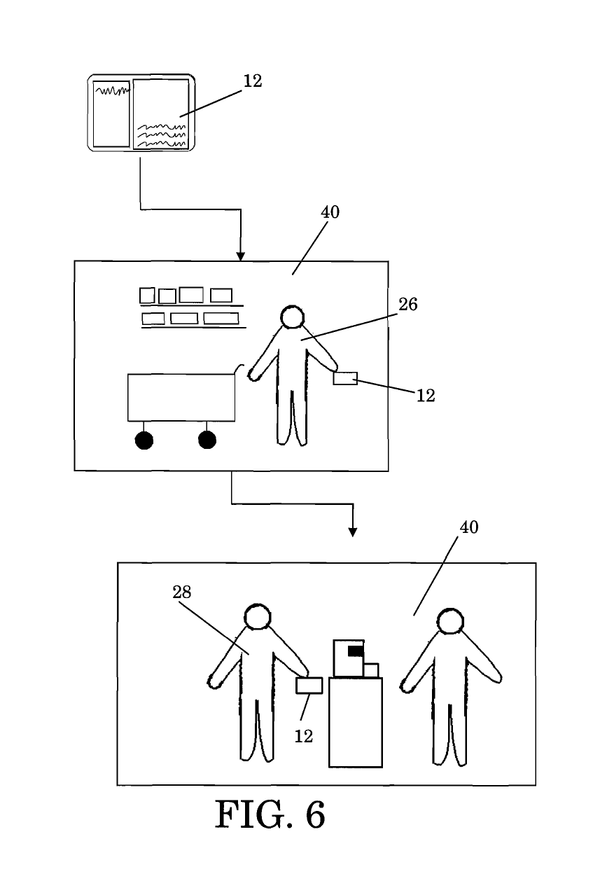

The first portion 18 includes indicia 22 or other information such as directions regarding use of the incentive system 10 of the present invention, and for a second customer 28 receiving a second incentive 44. For example, a business such as a car dealership or garage may wish to promote oil change services. In that example, indicia 22 of the front face 23 of the first portion 18 may read: “GIVE THIS CARD to a friend or family member. They will get their first oil change for $______, and their ______th oil change is FREE!” Thus, the indicia 22 advises of a second incentive 44 to be earned or provided to by a second customer 28. In that manner, the business utilizing the card 12 of the present invention provides an incentive for a first (or original) customer 26 obtaining the card 12 to distribute the card 12 to a second customer 28, so that the second (or potential or new) customer 28 can obtain the benefit of the incentive, as illustrated in FIG. 6. The cost of the initial product or service is set by the business as is the number of times “n” that a new customer would have to purchase the product or service in order to obtain the incentive, e.g., the free (or discounted) product or service.

The first portion 18 further includes a rear face 24 which may include additional indicia 22. Preferably, the rear face 24 of the first portion 18 includes indicia 22 such as information pertaining to the first customer 26. For example, the rear face 24 of the first portion 18 may include text advising the first customer 26 to pass the card 12 along to a second customer 28. In addition, the rear face 24 of the first portion 18 of the card 12 preferably includes text advising that a first customer 26 that passes the card 12 along to another potential or second customer 28 will receive free goods and/or services as a first incentive 42 to the first customer 26. The rear face 24 of the first portion 18 of the card 12 preferably includes a means for associating the card 12 with the first customer 26, such as a signature or name box 32 or line where the name of the first customer 26 is placed so that the first customer 26 customer can receive their free goods and/or services, as described in greater detail below. The means for associating the first customer 26 with a specific card 12 may include a unique code, color or other procedure for associating the particular card 12 with a particular first customer 26.

It is appreciated that the incentive system 10 and card 12 of the present invention can include as many incentives as a business chooses. For example, the first incentive 42 to the first customer 26 may be a free service, and also a discount on goods and/or services. Similarly the second incentive 44 may include an initial discount to entice a second customer 28 to patronize the business 40, and further may include free goods and/or services if the second customer 28 returns to the business 40 for additional goods and/or services. In this manner, the incentive system 10 and card 12 of the present invention provides both a means for a business 40 to obtain new customers, and also provides a means to retain customers with loyalty-type rewards.

The second portion 20 of the card 12 includes a front face 34 and a rear face 36. The second portion 20 is sized to be smaller than the first portion 18, as shown in FIGS. 1-3. In a preferred embodiment, the second portion is oriented ninety degrees relative to the first portion 18, as shown in FIGS. 1-3. Scores lines 30 are provided along the periphery of the second portion 20, so that the second portion 20 may be separated from the other portions of the card 12. The second portion 20 is sized so that it may be attached to a keychain, and is provided with a punch-out circle 38 providing a hole for such attachment.

The front face 34 of the second portion 20 preferably includes indicia, such as symbols and text, for tracking use of the card 12 and incentive system 10 by the second customer 28. For example, as shown in FIGS. 1 and 2, text is provided so that the business utilizing the card 12 and incentive system 10 can track how many times the second customer 28 patronizes the business. The business utilizing the card 12 and incentive system 10 of the present invention can select a number of times “n” that a second customer 28 must patronize the business in order to earn an incentive such as another discount or free goods and/or services.

In one example of how the incentive system 10 of the present invention works, a business owner establishes that free goods or services may be earned after a second customer 28 patronizes the business a total of, for example, five (5) times. The first time the second customer 28 patronizes the business, they may receive discounted goods or services. The second, third and fourth time the second customer 28 patronizes the business, they pay the normal (or a discount) fee for the goods or services. The fifth time the second customer 28 patronizes the business, they receive free goods or services.

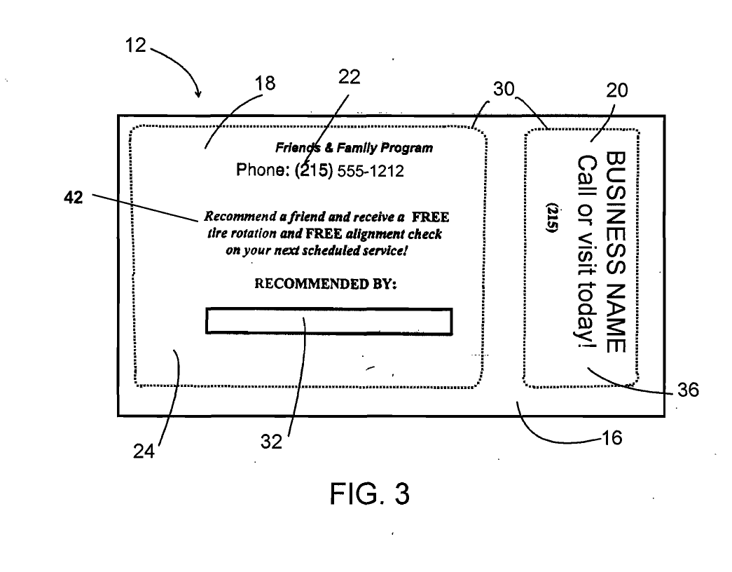

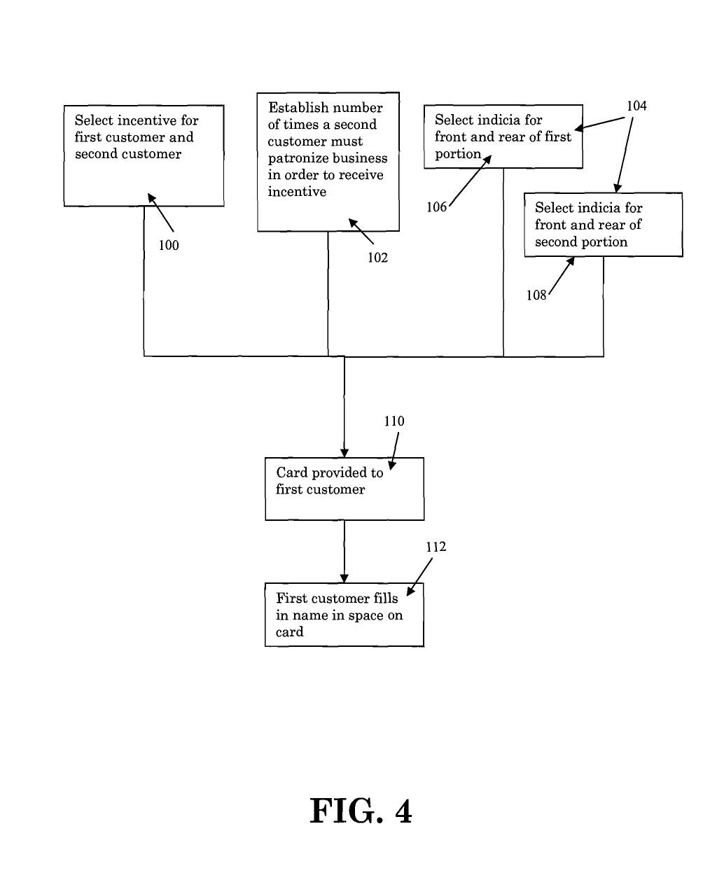

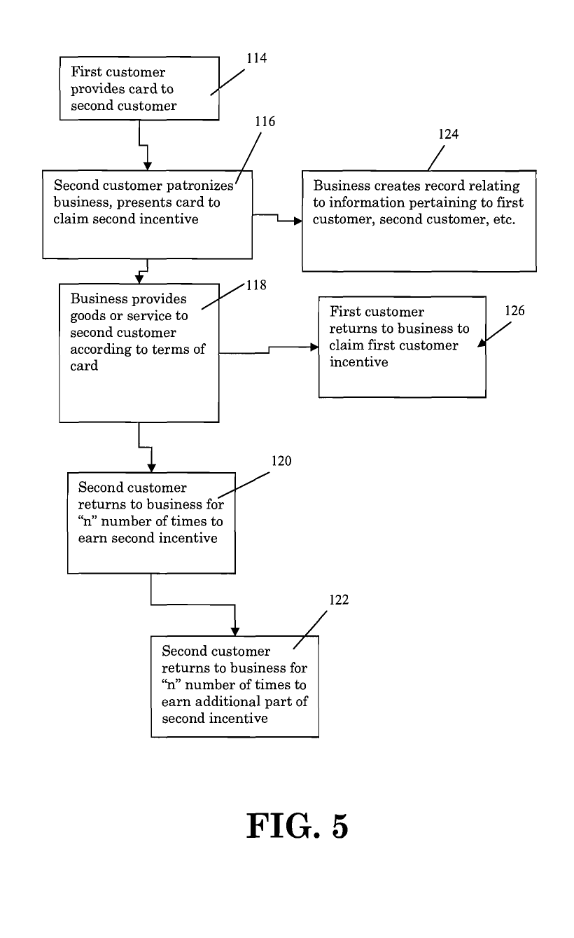

The operation of the incentive system 10 of the present invention utilizing at least one card 12 as described herein, will now be described, with reference to FIGS. 4 and 5. Initially, a business, for example an automotive service business, selects the goods and/or services to be tied to the incentive system 10, for both a first customer 26 and a second customer 28, illustrative as 100 in FIG. 4. For example, in the embodiments shown in FIGS. 2 and 3, the incentive for the first customer is a free tire rotation or free alignment check on the first customer's next scheduled service. The incentive for the second customer 28 is a discount oil change service, and potentially a free oil change service, after a certain number of visits to the business. The business also establishes the number of times a second customer 28 must patronize the business in order to receive an incentive, such as a discount or free goods and/or services, illustrated as 102 in FIG. 4. In the embodiment shown in FIGS. 1-3, the business has selected five (5) as the number of times a second customer 28 must patronize the business in order to receive an incentive. The business then selects the indicia 22 to be included on the front face 14 and rear face 16 of the card 12, illustrated as 104 in FIG. 4, such as selecting the indicia 22 to be included on the front face 23 and rear face 24 of the first portion 18 (illustrated in FIG. 4 as 106), and selecting the indicia 22 to be included on the front face 34 and rear face 36 of the second portion 20 (illustrated in FIG. 4 as 108).

The card 12 is given to a first customer 26 that is a current patron of the business, illustrated as 110 in FIG. 4. The first customer 26 fills in their name in the space provided, illustrated as 112 in FIG. 4. The card 12 is now ready to be given to a second customer 28, so that both the first customer 26 and the second customer 28 receive an incentive of some kind.

As shown in FIG. 5, the first customer 26 next gives the card to a second customer 28, illustrated as 114. The second customer 28 patronizes the business 40, and presents the card 12, illustrated in FIG. 5 as 116. The business 40 provides goods or service to second customer 28 according to terms of card 12, illustrated in FIG. 5 as 118. The second customer 28 returns to business for “n” number of times to earn the second incentive 44, illustrated in FIG. 5 as 120.

Because the card 12 includes the name of the first customer 26 on a face of the first portion 18 of the card 12, the business now has a record that the first customer 26 did, in fact, pass the card 12 on to a second customer 28 in order to increase patronage for the business. As shown in FIG. 5, the second customer returns to the business for “n” number of times, to earn an additional part of the second incentive 44, illustrated in FIG. 5 as 122. In this manner, the incentive system 10 of the present invention has generated both new and repeat business. The first customer 26 returns to business 40 to claim first customer incentive 42, as illustrated in FIG. 5 as 126.

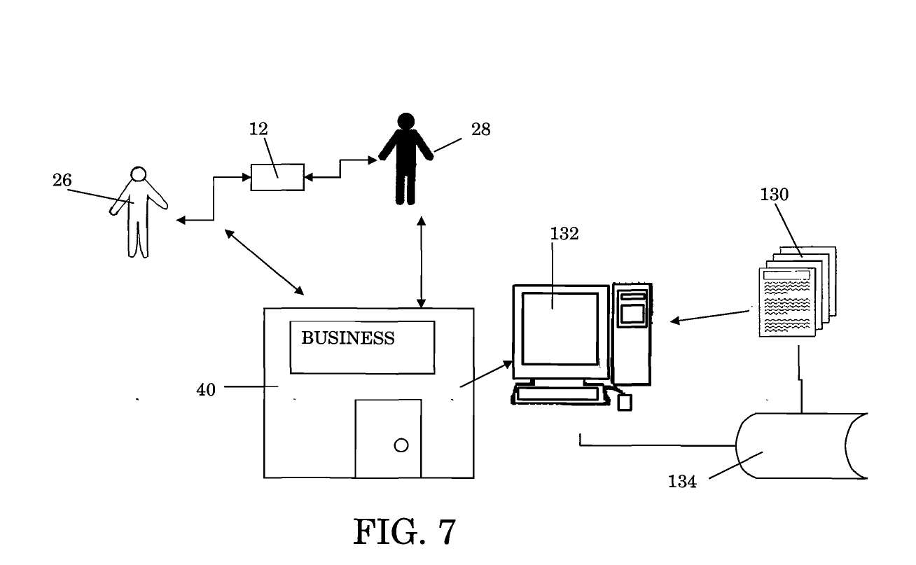

As shown in FIG. 7, the business 40 may maintain a record 130, either written or electronically, to keep track of the first customer 26, and/or the fact that the first customer 26 has earned the first incentive 42, and/or any other information that the business 40 wishes to track and/or store, as illustrated in FIG. 5 as 124. The business 40 may further maintain a record, either written or electronically (such as maintained in a computer or database), to keep track of the second customer 28, and the fact that the first customer 26 has earned the first incentive 42. Cards 12 may be provided with bar codes that may be scanned by a scanner connected to a computer system located at a business for tracking customers and cards 12. The information may be maintained by a computer 132 including software and a database 134 for collecting, organizing and analyzing information collection by the incentive system 10 of the present invention. In this manner, a marketing system is created that tracks consumer use and redemption of the cards 12, and allows a business to make marketing decisions based on the information collected. The business may also utilize the information collected from the cards or customer information collected through distribution or use of the cards in order to create targeted marketing programs, adjust product or service prices, determine effectiveness of different incentives, or create or develop future incentive programs. Thus, the incentive system 10 of the present invention provides a business with a novel and useful marketing tool.

Having thus described in detail several embodiments of the present invention, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiments are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all other embodiments and changes to these embodiments which come within the meaning and range of equivalency of said claims are therefore to be embraced therein.

What is claimed is:

1. An incentive article for use by a business in providing an incentive to a first customer and a second customer, comprising:
a card comprising:
a first portion including indicia thereon advising the first customer to provide the card to a second customer in order to receive an incentive, and,
a second portion including indicia thereon providing an incentive to a second customer for patronizing the business.

2. The incentive article of claim 1, wherein the first portion is separable from the card.

3. The incentive article of claim 2, wherein the second portion is separable from the card.

4. The incentive article of claim 1, wherein the first portion includes a front face and a rear face, and where a name space is provided on one of the front face and rear face.

5. The incentive article of claim 1, wherein the second portion is adapted for securing on a keychain or key ring.

6. The incentive article of claim 1, wherein the card is provided with a unique bar code for tracking the card.

7. The incentive article of claim 1, wherein the card further includes indicia advising the second customer to patronize a business to receive the second incentive.

8. The incentive article of claim 1, wherein the second portion includes indicia for tracking the second customer's patronage of the business.

9. A method for a business to provide an incentive to a first customer and a second customer, comprising the steps of:
(a) selecting incentives to be provided to a first customer and a second customer;
(b) providing a card including indicia for communicating the incentives to a first customer;
(c) associating the card with the first customer;
(d) transferring the card from the first customer to the second customer; and,
(e) providing one of the incentives to the second customer when the second customer returns the card to a business.

10. The method of claim 9, further comprising the step of providing one of the incentives to the first customer after step (e).

11. The method of claim 9, a card comprising a first portion including indicia thereon advising the first customer to provide the card to a second customer in order to receive an incentive; and, a second portion including indicia thereon providing an incentive to a second customer for patronizing the business.

12. The method of claim 9, further comprising the step of selecting the number of times a second customer must visit a business to earn one of the incentives before step (b).
